(19) United States
(12) Patent Application Publication
(10) Pub. No.: US 2010/0080911 A1
(43) Pub. Date: Apr. 1, 2010

(54) Method of Ink-Jet Recording, Pretreatment Liquid, Ink Set, Ink-Jet Recording Apparatus, and Methods of Improving Optical Density of Recorded Object and Improving Quick-Drying Ability of Pigment Ink

(75) Inventor: Goro Okada, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/564,955

(22) Filed: Sep. 23, 2009

(30) Foreign Application Priority Data
Sep. 30, 2008 (JP) 2008-255341

(51) Int. Cl. B05D 5/00; C09D 5/00; C09D 11/02

(52) U.S. Cl. 427/256; 106/287.24; 106/31.6; 347/100

(57) ABSTRACT

A method of ink-jet recording includes a pretreatment process applying a pretreatment liquid onto a recording medium in advance of ink-jet recording, and a recording process recording by ejecting a pigment ink onto the recording medium by an ink-jet method. The pretreatment liquid contains at least one selected from the group consisting of succinic acid, succinic acid salt, acetic acid, and acetic acid salt; and water.

### CROSS-REFERENCE TO RELATED APPLICATION

This application claims priority from Japanese Patent Application No. 2008-255341 filed on Sep. 30, 2008. The entire subject matter of the Japanese Patent Application is incorporated herein by reference.

### BACKGROUND

With the aim of improving recording quality of ink-jet recording, a treatment liquid is prepared separately from an ink and the treatment liquid is applied to a recording paper. For example, a treatment liquid using resin and metal oxide having the same color as the recording paper has been suggested. By applying the treatment liquid onto a rear surface (the other side of a recording surface) of a recording paper before or after recording, or simultaneously with recording, an ink concentration at the rear surface of the recording paper is decreased, and a so-called ink strike-though is prevented. Thereby, contrast of a recorded object is improved, and recording quality is improved in this point.

On the other hand, in accordance with increase in recording speed of an ink-jet recording apparatus, with respect to ink, penetrability and quick-drying ability to the recording paper are required. However, when penetrability of ink is increased, optical density of a recorded object is decreased, and recording quality may be deteriorated in this point. Further, a method using the aforementioned treatment liquid does not improve optical density and quick-drying ability. Further, since some components of the ink-jet recording apparatus are directly in contact with the treatment liquid, corrosion of components of the apparatus may occur.

### SUMMARY

A method of ink-jet recording comprises a pretreatment process applying a pretreatment liquid onto a recording medium in advance of ink-jet recording, and a recording process recording by ejecting a pigment ink onto the recording medium by an ink-jet method. The pretreatment liquid comprises at least one selected from the group consisting of succinic acid, succinic acid salt, acetic acid, and acetic acid salt (hereinafter, it may also be referred to as “succinic acid, acetic acid, or the like”); and water.

A pretreatment liquid is a pretreatment liquid for applying onto a recording medium in ink-jet recording using a pigment ink in advance of the ink-jet recording. The pretreatment liquid comprises the succinic acid, acetic acid, or the like; and water.

An ink set comprises a pigment ink and the pretreatment liquid.

An ink-jet recording apparatus comprises an ink storing portion and an ink ejecting unit. An ink stored in the ink storing portion is ejected by the ink ejecting unit. The ink-jet recording apparatus further comprises a pretreatment liquid applying unit.

A method of improving optical density of a recorded object comprises a pretreatment process applying a pretreatment liquid onto a recording medium in advance of ink-jet recording, and a recording process recording by ejecting a pigment ink onto the recording medium by an ink-jet method. The pretreatment liquid comprises the succinic acid, acetic acid, or the like; and water. Optical density of the recorded object is improved by applying the pretreatment liquid onto at least an area to be recorded of a recording surface of the recording medium to be recorded with the pigment ink in the pretreatment process, and by aggregating pigments in the pigment ink at the recording surface due to the succinic acid, acetic acid, or the like in the pretreatment liquid in the recording process.

A method of improving quick-drying ability of a pigment ink comprises a pretreatment process applying a pretreatment liquid onto a recording medium in advance of ink-jet recording, and a recording process recording by ejecting a pigment ink onto the recording medium by an ink-jet method. The pretreatment liquid comprises the succinic acid, acetic acid, or the like; and water. Quick-drying ability of the pigment ink is improved by applying the pretreatment liquid onto at least an area, corresponding to an area to be recorded, of the other side of a recording surface of the recording medium to be recorded with the pigment ink in the pretreatment process, and by aggregating pigments in the pigment ink, penetrated into the recording medium from the recording surface, at an intermediate layer of the recording medium due to the succinic acid, acetic acid, or the like, penetrated into the recording medium from the other side of the recording surface, in the recording process.

### BRIEF DESCRIPTION OF THE DRAWINGS

FIGS. 1(A) and 1(B) are views showing examples of recording by the ink-jet recording method.

FIGS. 2(A) to 2(C) are a process drawing showing an example of a process of the ink-jet recording method.

FIGS. 3(A) to 3(E) are a process drawing showing another example of a process of the ink-jet recording method.

FIG. 4 is a block diagram showing an example of the configuration of the ink-jet recording apparatus.

FIG. 5 is a block diagram showing another example of the configuration of the ink-jet recording apparatus.

### DETAILED DESCRIPTION

In the ink-jet recording method, for example, an area of the recording medium applied with the pretreatment liquid corresponds to at least an area to be recorded of a recording surface (hereinafter, referred to as a “front surface”) of the recording medium to be recorded with a pigment ink or at least an area, corresponding to the area to be recorded, of the other side of the recording surface (hereinafter, referred to as a “rear surface”) of the recording medium to be recorded with the pigment ink.

Next, the ink-jet recording method is explained in detail. As described above, the ink-jet recording method comprises a pretreatment process and a recording process.

The recording medium to be recorded in the ink-jet recording method is, for example, a recording paper. The recording paper is a plain paper, for example. In the present invention, the “plain paper” is a paper, which is not applied with special processing or special treatment on a recording surface thereof, such as a quality paper used for a notebook, a report paper, and the like; an uncoated copy paper; and the like. Examples of the plain paper comprises “Laser Print” manufactured by Hammermill, “DATA COPY PAPER” manufactured by M-real, “Xerox 4200” manufactured by XEROX CORPORATION, “4200DP PAPER” manufactured by FUJI XEROX OFFICE SUPPLY CO. LTD., and the like.

The pretreatment process is a process applying a pretreatment liquid onto a recording medium in advance of ink-jet recording.

A pretreatment liquid used in the pretreatment process comprises the succinic acid, acetic acid, or the like; and water.

The succinic acid, acetic acid, or the like has a function of aggregating pigments in the pigment ink when the pretreatment liquid is in contact with the pigment ink on the recording medium. The succinic acid, acetic acid, or the like is, for example, a succinic acid or an acetic acid. Examples of the succinic acid salt comprise sodium succinate, potassium succinate, and the like. Examples of the acetic acid salt comprise sodium acetate, potassium acetate, and the like. The amount of the succinic acid, acetic acid, or the like to be added with respect to the total amount of the pretreatment liquid is, for example, in the range of about 1 wt % to about 10 wt %, and in the range of about 1 wt % to about 5 wt %.

The water may be ion-exchange water or purified water. The amount of the water to be added (water ratio) with respect to the total amount of the pretreatment liquid may be a balance of the other components, for example.

The pretreatment liquid further comprises glycol ether. The glycol ether is, for example, dipropylene glycol-n-propyl ether (DPP) and diethylene glycol-n-hexyl ether (DEHE). Glycol ether other than DPP and DEHE may be used. Examples of glycol ether other than DPP and DEHE comprise ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-butyl ether, tripropylene glycol methyl ether, tripropylene glycol ethyl ether, tripropylene glycol-n-propyl ether, tripropylene glycol-n-butyl ether, and the like. The amount of the glycol ether to be added with respect to the total amount of the pretreatment liquid is, for example, in the range of about 1 wt % to about 15 wt %, and in the range of about 2 wt % to about 10 wt %. In addition to the succinic acid, acetic acid, or the like, glycol ether, and water, the pretreatment liquid may further comprise other components.

The pretreatment liquid improves optical density or quick-drying ability depending on a surface of the recording medium that is applied therewith. When the pretreatment liquid is applied to the front surface of the recording medium, optical density is improved. When the pretreatment liquid is applied to the rear surface of the recording medium, quick-drying ability is improved. With respect to mechanism of improvement of these characteristics, the inventors estimate as follows. That is, first, when the pretreatment liquid is applied to the front surface of the recording medium, pigments in a pigment ink are efficiently aggregated on the front surface of the recording paper due to the succinic acid, acetic acid, or the like. As a result, optical density of a recorded object is improved. On the other hand, when the pretreatment liquid is applied to the rear surface of the recording medium, the succinic acid, acetic acid, or the like is penetrated into the recording medium from the rear surface toward the front surface. The pigments of the pigment ink are penetrated from the front surface of the recording medium toward the rear surface, and the pigments are aggregated and settled in an intermediate layer of the recording medium due to the succinic acid, acetic acid, or the like. As a result, quick-drying ability of a pigment ink is improved. These mechanisms are mere estimations and the present invention is not restricted or limited by these estimations. Further, the quick-drying ability means that a pigment ink settles on a recording medium for a short period of time after recording and the pigment ink does not transfer even when the recording medium is in contact with the other components of an ink-jet recording apparatus and a recording medium discharged to a paper discharging portion. The recording comprises, for example, printing of letters, images, and the like.

In the pretreatment process, the pretreatment liquid may be applied by an ink-jet method, a stamping method, a brushing method, a rolling method, and the like. The ink-jet method is a method of applying the pretreatment liquid onto the recording medium by ejecting, for example. The stamping method, the brushing method, and the rolling method are, as the names suggest, methods of applying the pretreatment liquid with a stamp, a brush, and a roller, respectively.

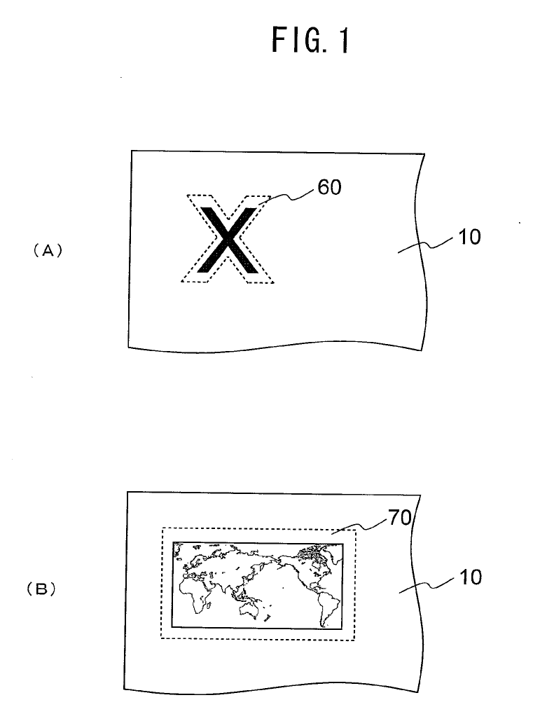

In the pretreatment process, the surface of the recording medium applied with the pretreatment liquid is decided suitably according to purposes. As described above, the surface of the recording medium applied with the pretreatment liquid is the front surface when improvement of optical density is aimed, and is the rear surface when improvement of quick-drying ability is aimed. Further, the pretreatment liquid may be applied to the whole surface of the front surface or the rear surface of the recording medium or applied to a part of the front surface or the rear surface of the recording medium. When a part of the surface of the recording medium is applied with the pretreatment liquid, at least an area to be recorded of the front surface of the recording medium is a pretreatment liquid applied area or an area, corresponding to the area to be recorded, of the rear surface of the recording medium is a pretreatment liquid applied area. When a part of the surface of the recording medium is recorded, the pretreatment liquid applied area is larger than the area to be recorded, for example. For example, as shown in FIG. 1(A), when the letter “X” is recorded on a recording paper 10, a pretreatment liquid is applied to form a pretreatment liquid applied area 60 having a line width wider than that of the letter. Further, for example, as shown in FIG. 1(B), when an image is recorded on the recording paper 10, a pretreatment liquid is applied to form a pretreatment liquid applied area 70 that is larger than the image.

Next, the recording process is a process for recording by ejecting a pigment ink onto a recording medium by an ink-jet method.

As for the pigment ink used in the recording process, for example, an ink comprising a pigment, water, and a water-soluble organic solvent may be used.

For example, carbon black, an inorganic pigment, an organic pigment, and the like may be used as the pigment. Examples of the carbon black comprise furnace black, lamp black, acetylene black, channel black, and the like. Examples of the inorganic pigment comprise titanium oxide, iron oxide inorganic pigment, carbon black inorganic pigment, and the like. Examples of the organic pigment comprise azo pigments such as azo lake, an insoluble azo pigment, a condensed azo pigment, a chelate azo pigment, and the like; polycyclic pigments such as a phthalocyanine pigment, a perylene and perynone pigment, an anthraquinone pigment, a quinacridone pigment, a dioxazine pigment, a thioindigo pigment, an isoindolinone pigment, a quinophthalone pigment, and the like; dye lake pigments such as a basic dye lake pigment, an acid dye lake pigment, and the like; a nitro pigment; a nitroso pigment; an aniline black daylight fluorescent pigment; and the like. Further, other pigments may be used as long as they are dispersible to an aqueous phase. Specific examples of the pigments comprise C. I. Pigment Black 1, 6, and 7; C. I. Pigment Yellow 1, 2, 3, 12, 13, 14, 15, 16, 17, 55, 73, 74, 75, 83, 93, 94, 95, 97, 98, 114, 128, 129, 138, 150, 151, 154, 180, 185, and 194; C. I. Pigment Orange 31 and 43; C. I. Pigment Red 2, 3, 5, 6, 7, 12, 15, 16, 48, 48:1, 53:1, 57, 57:1, 112, 122, 123, 139, 144, 146, 149, 166, 168, 175, 176, 177, 178, 184, 185, 190, 202, 221, 222, 224, and 238; C. I. Pigment Violet 196; C. I. Pigment Blue 1, 2, 3, 15, 15:1, 15:2, 15:3, 15:4, 16, 22, and 60; C. I. Pigment Green 7 and 36; and the like.

The pigment comprises a self-dispersed pigment, for example. The self-dispersed pigment is a pigment that is dispersible to water, without using a dispersant, by introducing at least one of hydrophilic functional groups such as a carboxyl group, a carbonyl group, a hydroxyl group, a sulfonic group, and the like; and their salts into a surface of a pigment particle directly or through other groups by chemical bond.

As the self-dispersed pigment, for example, a self-dispersed pigment, the surface thereof is treated according to methods described in JP8(1996)-3498A, JP2000-513396A, and the like, may be used. For example, a commercially available self-dispersed pigment may used. Examples of the commercially available self-dispersed pigment comprise CAB-O-JET® 200, CAB-O-JET® 250, CAB-O-JET® 260, CAB-O-JET® 270, CAB-O-JET® 300, and CAB-O-JET® 700, manufactured by Cabot Specialty Chemicals, Inc.; BONJET® BLACK CW-1, BONJET® 0BLACK CW-2, and BONJET® BLACK CW-3, manufactured by Orient Chemical Industries, Ltd.; LIOJET® WD BLACK 002C, manufactured by TOYO INK MFG. CO., LTD.; and the like.

As a pigment used as a material of the self-dispersed pigment, either an inorganic pigment or an organic pigment may be used. Further, examples of a pigment suitable to the surface modification comprise carbon blacks such as MA8 and MA100, manufactured by Mitsubishi Chemical Corporation; COLOR BLACK FW 200, manufactured by Evonik Degussa; and the like.

The amount of the pigment to be added (pigment ratio; pigment solid content) with respect to the total amount of the pigment ink is decided suitably according to an optical density, color, or the like desired for a recorded object, for example. The pigment ratio is, for example, in the range of about 0.1 wt % to about 20 wt %, and in the range of about 0.3 wt % to about 15 wt %. One of the pigments may be used alone or two or more of them may be used in combination.

The water may be ion-exchange water or purified water. The amount of the water to be added (water ratio) with respect to the total amount of the pigment ink may be a balance of the other components, for example.

Examples of the water-soluble organic solvent comprise a humectant and a penetrant. The humectant prevents ink from drying at a tip of a nozzle of an ink-jet head, for example. The penetrant adjusts a drying rate of ink on a recording medium, for example.

Examples of the humectant comprise lower alcohol such as methyl alcohol, ethyl alcohol, n-propyl alcohol, isopropyl alcohol, n-butyl alcohol, sec-butyl alcohol, tert-butyl alcohol, and the like; amide such as dimethylformamide, dimethylacetamide, and the like; ketone such as acetone, and the like; ketoalcohol such as diacetone alcohol, and the like; ether such as tetrahydrofuran, dioxane, and the like; polyalcohol such as polyalkylene glycol, alkylene glycol, glycerin, and the like; 2-pyrrolidone; N-methyl-2-pyrrolidone; 1,3-dimethyl-2-imidazolidinone; and the like. Examples of the polyalkylene glycol comprise polyethylene glycol, polypropylene glycol, and the like. Examples of the alkylene glycol comprise ethylene glycol, propylene glycol, butylene glycol, diethylene glycol, triethylene glycol, dipropylene glycol, tripropylene glycol, thiodiglycol, hexylene glycol, and the like. One of the humectants may be used alone or two or more of them may be used in combination. Among them, for example, the humectant is polyalcohol such as alkylene glycol, glycerin, and the like.

The amount of the humectant to be added (humectant ratio) with respect to the total amount of the pigment ink is, for example, in the range of about 0 wt % to about 95 wt %, in the range of about 5 wt % to about 80 wt %, and in the range of about 5 wt % to about 50 wt %.

An example of the penetrant comprises glycol ether. Examples of the glycol ether comprise ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, tripropylene glycol-n-butyl ether, and the like. One of the penetrants may be used alone or two or more of them may be used in combination.

The amount of the penetrant to be added (penetrant ratio) with respect to the total amount of the pigment ink is, for example, in the range of about 0 wt % to about 20 wt %. Setting of the penetrant ratio in the aforementioned range makes it possible to obtain suitable penetrability of the pigment ink relative to a recording medium such as a paper. The penetrant ratio is, for example, in the range of about 0.1 wt % to about 15 wt %, and in the range of about 0.5 wt % to about 10 wt %.

The pigment ink may further comprise a conventionally known additive as required. Examples of the additive comprise a surfactant, a viscosity modifier, a surface tension modifier, a mildewproofing agent, and the like. Examples of the viscosity modifier comprise polyvinyl alcohol, cellulose, water-soluble resin, and the like.

The pigment ink may be prepared by uniformly mixing a pigment, water, and a water-soluble organic solvent with other added components as required by a conventionally known method, and then removing insolubles with a filter, for example.

Ink-jet recording in the recording process may be performed by ejecting a pigment ink onto a recording medium using an ink-jet head.

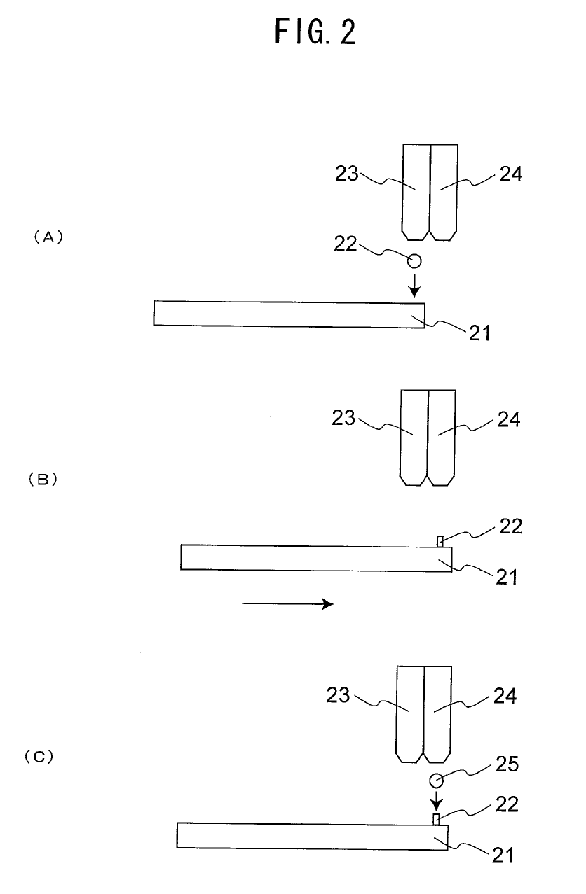

An example of the ink-jet recording method is explained. First, as shown in FIG. 2(A), a pretreatment liquid applied area is formed by ejecting a pretreatment liquid 22 from a nozzle 23 of an ink-jet head onto a recording area of a surface of a recording paper 21. Next, as shown in FIG. 2(B), the recording paper 21 is moved in a direction of an arrow. Then, as shown in FIG. 2(C), recording is performed by ejecting a pigment ink 25 onto the pretreatment liquid applied area using a nozzle 24 of the ink-jet head. In this example, the pigment ink 25 is aggregated due to the pretreatment liquid 22, and as a result, a recorded object with high optical density is obtained.

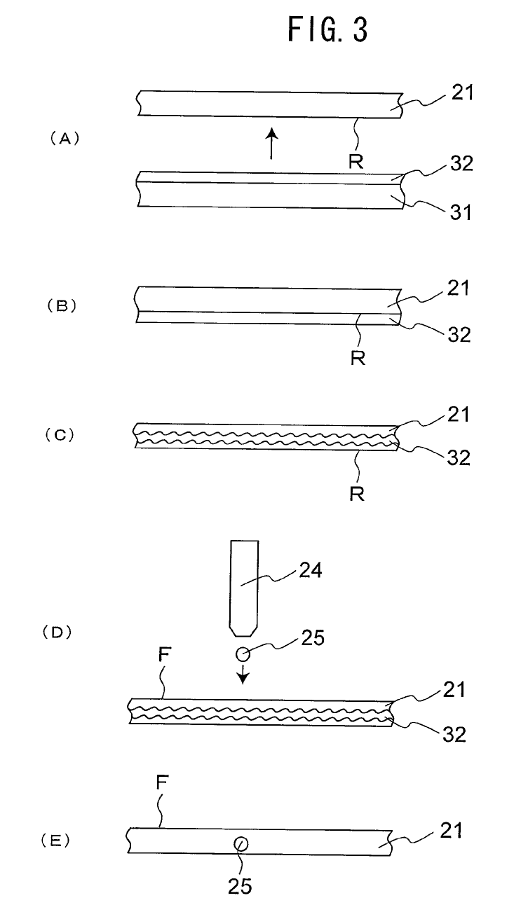

Another example of the ink-jet recording method is explained. In this example, a pretreatment liquid is applied to the rear surface of a recording paper by stamping. First, as shown in FIG. 3(A), a stamp 31 applied with a pretreatment liquid 32 at a stamp surface thereof is disposed at a rear surface R side of a recording paper 21, and as indicated by an arrow, the stamp 31 is moved and brought into contact with the rear surface R of the recording paper 21. Thereafter, when the stamp surface is moved away from the rear surface R of the recording paper 21, due to contact with the stamp surface, as shown in FIG. 3(B), the pretreatment liquid 32 is transferred to the rear surface R of the recording paper 21. Then, as shown in FIG. 3(C), the pretreatment liquid 32 is penetrated into the recording paper 21 from the rear surface R. Next, as shown in FIG. 3(D), a pigment ink 25 is ejected from a nozzle 24 of an ink-jet head onto a front surface F of the recording paper 21. The pigment ink 25 thus ejected is, as shown in FIG. 3(E), penetrated into the recording paper 21 from the front surface F and aggregated by contacting with the pretreatment liquid 32. As a result, the pigment ink 25 is settled in the recording paper 21 for a short period of time, and quick-drying ability is thereby improved.

In the ink-jet recording method, pretreatment liquid comprising the succinic acid, acetic acid, or the like is used. Therefore, according to the ink-jet recording method, corrosion of components of an ink-jet recording apparatus due to the pretreatment liquid may not occur.

According to the present invention, a pretreated recording medium, which is formed by applying the pretreatment liquid onto at least an area to be recorded of the front surface of a recording medium or onto an area, corresponding to the area to be recorded, of the rear surface of the recording medium, is obtained.

Next, the ink-jet recording apparatus is explained. As described above, the ink-jet recording apparatus comprises an ink storing portion and an ink ejecting unit. An ink stored in the ink storing portion is ejected by the ink ejecting unit. The ink-jet recording apparatus further comprises a pretreatment liquid applying unit. Other than these, the configuration of the ink-jet recording apparatus may be similar to that of conventionally known ink-jet recording apparatuses. The pretreatment liquid may be stored in the ink storing portion. Alternatively, a storing portion for the pretreatment liquid may separately be provided.

The ink-jet recording apparatus is, for example, an ink-jet recording apparatus to which a line-type ink-jet head is mounted. However, the ink-jet recording apparatus is not limited thereto. The ink-jet recording apparatus may be, for example, an ink-jet recording apparatus to which a serial-type ink-jet head is mounted. The line-type ink-jet recording apparatus performs recording in a width direction of the recording medium all at once, using a line-type ink-jet head having a recording width equal to or wider than a width of the recording medium, in a condition where the ink-jet head is fixed. In contrast, the serial-type ink-jet recording apparatus performs recording by moving the ink-jet head itself in the width direction of the recording medium. The recording speed of the line-type ink-jet recording apparatus is considerably faster than that of the serial-type ink-jet recording apparatus.

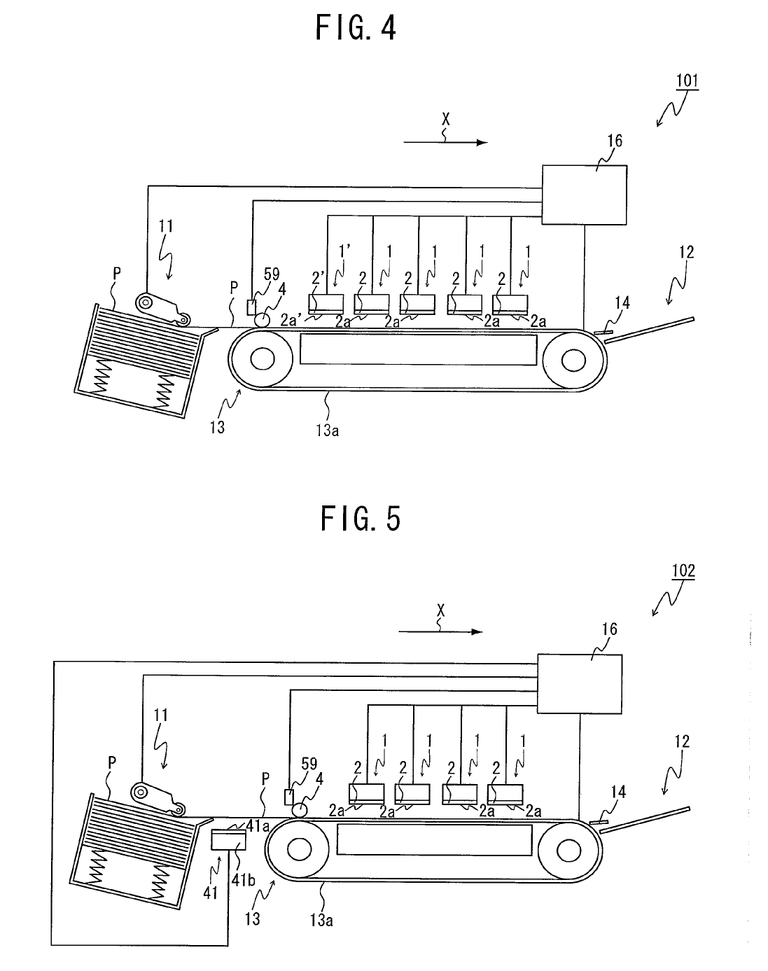

In FIG. 4, an ink-jet recording apparatus 101 of this example is provided with a line-type ink-jet head and applies the pretreatment liquid onto a recording paper P by an ink-jet method. As shown in FIG. 4, the ink-jet recording apparatus 101 comprises a pretreatment liquid cartridge 1′, four ink cartridges 1, a pretreatment liquid head 2′, four ink-jet heads 2, a paper feeding portion 11, a paper discharging portion 12, a belt transferring mechanism 13, and a control device 16 for controlling the whole ink-jet recording apparatus 101 as main components. The pretreatment liquid cartridge 1′ has the same configuration as the ink cartridge 1. Likewise, the pretreatment liquid head 2′ has the same configuration as the ink-jet head 2. The paper feeding portion 11 is disposed at one side of the belt transferring mechanism 13 (left side in FIG. 4). The paper discharging portion 12 is disposed at the other side of the belt transferring mechanism 13 (right side in FIG. 4).

In the ink-jet recording apparatus 101, a recording paper transferring path is formed in which the recording paper P is transferred toward the paper discharging portion 12 from the paper feeding portion 11 through the belt transferring mechanism 13. An arrow X indicates a recording paper transferring direction in which the recording paper P is transferred. As the paper feeding portion 11, the belt transferring mechanism 13, and the paper discharging portion 12, for example, a conventionally known paper feeding portion, belt transferring mechanism, and paper discharging portion may be used (see JP2007-326242A). In FIG. 4, numeral 59 indicates a recording paper detection sensor. The recording paper detection sensor 59 detects whether the recording paper P fed from the paper feeding portion 11 is reached a recording waiting position located at an upstream side (left side in FIG. 4) of the belt transferring mechanism 13 in a recording paper transferring direction X.

In FIG. 4, numeral 4 indicates a nip roller. The nip roller 4 presses the recording paper P to a circumferential surface 13a of the belt transferring mechanism 13 when the recording paper P fed into the belt transferring mechanism 13 is placed on the circumferential surface 13a of the belt transferring mechanism 13. At a downstream side of the belt transferring mechanism 13, a detaching mechanism 14 is provided. The detaching mechanism 14 detaches the recording paper P, which is adhered to the circumferential surface 13a of the belt transferring mechanism 13, from the circumferential surface 13a and sends the recording paper P to the paper discharging portion 12.

The pretreatment liquid cartridge 1′ comprises the pretreatment liquid. Each of the four ink cartridges 1 comprises one of a yellow ink, a magenta ink, a cyan ink, and a black ink. For example, the black ink is the pigment ink. The pretreatment liquid cartridge 1′ and the four ink cartridges 1 are fixed side by side above the belt transferring mechanism 13 along the recording paper transferring direction X. The pretreatment liquid cartridge 1′ and the four ink cartridges 1 respectively have the pretreatment liquid head 2′ and the ink-jet head 2 at the lower side thereof. When the recording paper P, which is transferred by the belt transferring mechanism 13, passes under the pretreatment liquid head 2′, the pretreatment liquid is ejected onto the front surface of the recording paper P from a pretreatment liquid ejecting surface 2a′. Subsequently, when the recording paper P, which is transferred by the belt transferring mechanism 13, passes under the four ink-jet heads 2 in order, each color of ink is ejected from each ink ejecting surface 2a. In this manner, recording is performed on the front surface of the recording paper P.

In the ink-jet recording apparatus shown in FIG. 4, the pretreatment liquid is applied onto the front surface of the recording paper P by an ink-jet method. However, the present invention is not limited thereto. In the ink-jet recording apparatus, the pretreatment liquid may be applied onto the front surface of the recording paper P by a stamping method, a brushing method, a rolling method, or the like. Further, in the ink-jet recording apparatus shown in FIG. 4, a line-type ink-jet head is employed. However, the present invention is not limited thereto. In the ink-jet recording apparatus, a serial-type ink-jet head may be employed.

In FIG. 5, an ink-jet recording apparatus 102 of this example applies the pretreatment liquid onto the rear surface of the recording paper P by stamping. Therefore, in the ink-jet recording apparatus 102 of this example, pretreatment liquid applying units by an ink-jet method (pretreatment liquid cartridge 1′, pretreatment liquid head 2′, and pretreatment liquid ejecting surface 2a′ in FIG. 4) are not provided. Other than these, the configuration of the ink-jet recording apparatus 102 of this example may be similar to that of the ink-jet recording apparatus shown in FIG. 4.

As shown in FIG. 5, in the ink-jet recording apparatus 102 of this example, a stamp 41 is disposed at the rear surface side of a recording paper P (below the recording paper P in FIG. 4) between a belt transferring mechanism 13 and a paper feeding portion 11. The stamp 41 has a stamping portion 41a and a pretreatment liquid storing portion 41b. The stamping portion 41a is formed of a superabsorbent substrate having flexibility. When recording is performed, the stamping portion 41a is brought into contact with the rear surface of the recording paper P and pretreatment liquid supplied from the pretreatment liquid storing portion 41b is applied onto the rear surface of the recording paper P.

In the ink-jet recording apparatus shown in FIG. 5, the pretreatment liquid is applied onto the rear surface of the recording paper P by stamping. However, the present invention is not limited thereto. In the ink-jet recording apparatus, the pretreatment liquid may be applied onto the rear surface of the recording paper P by an ink-jet method, a brushing method, a rolling method, or the like. Further, in the ink-jet recording apparatus shown in FIG. 5, a line-type ink-jet head is employed. However, the present invention is not limited thereto. In the ink-jet recording apparatus, a serial-type ink-jet head may be employed.

Next, a method of improving optical density of the recorded object is explained. As described above, the method of improving optical density of the recorded object comprises a pretreatment process applying a pretreatment liquid onto a recording medium in advance of ink-jet recording, and a recording process recording by ejecting a pigment ink onto the recording medium by an ink-jet method. The pretreatment liquid comprises succinic acid, acetic acid, or the like; and water. Optical density is improved by applying the pretreatment liquid onto at least an area to be recorded of the front surface of the recording medium in the pretreatment process, and by aggregating pigments in the pigment ink at the front surface due to the succinic acid, acetic acid, or the like in the recording process.

Next, a method of improving quick-drying ability of the pigment ink is explained. As described above, the method of improving quick-drying ability of the pigment ink comprises a pretreatment process applying a pretreatment liquid onto a recording medium in advance of ink-jet recording, and a recording process recording by ejecting a pigment ink onto the recording medium by an ink-jet method. The pretreatment liquid comprises succinic acid, acetic acid, or the like; and water. Quick-drying ability of the pigment ink is improved by applying the pretreatment liquid onto at least an area, corresponding to the area to be recorded, of the rear surface of the recording medium in the pretreatment process, and by aggregating pigments in the pigment ink penetrated into the recording medium from the front surface at an intermediate layer of the recording medium due to the succinic acid, acetic acid, or the like penetrated into the recording medium from the rear surface in the recording process.

In the method of improving optical density of the recorded object, for example, the pretreatment liquid further comprises glycol ether.

In the method of improving optical density of the recorded object, for example, the glycol ether is at least one of DPP and DEHE.

In the method of improving optical density of the recorded object and the method of improving quick-drying ability of the pigment ink, for example, the pigment ink comprises a self-dispersed pigment.

Other conditions of the method of improving optical density of the recorded object and the method of improving quick-drying ability of the pigment ink are similar to those of the ink-jet recording method, the pretreatment liquid, the ink set, and the ink-jet recording apparatus.

### Examples

Examples of the present invention are described together with Comparative Examples, which are provided for illustrative purposes only. The present invention is not limited by the following Examples and Comparative Examples.

<Preparation of Pretreatment Liquid>

Pretreatment liquid components in Tables 1 and 2 were uniformly mixed to prepare pretreatment liquids of Examples 1 to 9 and Comparative Examples 1 to 7.

<Preparation of Pigment Ink>

Pigment ink components in Table 3 excluding CAB-O-JET® 300 were uniformly mixed to prepare an ink solvent. Then, thus obtained ink solvent was gradually added to CAB-O-JET® 300 and then uniformly mixed. Thereafter, the obtained mixture was filtered with a cellulose acetate type membrane filter having a pore diameter of 3.00 μm manufactured by Toyo Roshi Kaisha, Ltd. to prepare two kinds of pigment inks (ink 1 and ink 2) for ink-jet recording.

Characteristics and properties in each Example and Comparative Example were measured and evaluated by the following method.

(1) Recording Quality Evaluation

On a film (OHP film, Multi-Purpose Transparency Film CG6000, manufactured by 3M), pretreatment liquid of each Example and Comparative Example was uniformly spread by a barcoater (BARCOATER rod No. 8, manufactured by Yasuda Seiki seisakusho LTD.). Next, a recording paper was placed on the film with the front surface down. Then, the front surface of the recording paper was brought into contact with the pretreatment liquid on the film and the pretreatment liquid was absorbed by the front surface, and thereby the pretreatment liquid was applied to the recording paper. The average amount of the pretreatment liquid applied to the recording paper (average application amount) was 1.1×10⁻⁶ g/mm². As the recording paper, a plain paper (Laser Print, manufactured by Hammermill) was used.

Subsequently, an ink cartridge mountable to an ink-jet multifunction printer called “DCP-330C” manufactured by Brother Industries, Ltd. was filled with one of the two kinds of pigment ink. Then, using the ink-jet multifunction printer, with respect to the front surfaces of recording papers each pretreated with the pretreatment liquid of Examples and Comparative Examples, by performing solid printing using the pigment ink with coverage of 100% and resolution of 600 dpi×600 dpi, recording by an ink-jet method was performed. In Examples 1 to 4, both of the two kinds of pigment ink (ink 1 and ink 2) were evaluated. In Examples 5 to 9 and Comparative Examples 1 to 3, 5 and 6, evaluation was performed using the ink 1. In Comparative Examples 4 and 7, evaluation was performed using the ink 2. Further, as Control Example 1, with respect to the surface of the recording paper not applied with the pretreatment liquid, recording was performed using the ink 1 by the ink-jet method in the same manner as in Examples and Comparative Examples. Furthermore, as Control Example 2, recording was performed in the same manner as in Control Example 1 except that the ink 2 was used instead of the ink 1. An optical density (OD) value of a recording area of a recording paper was measured with a spectrophotometer, “Spectrolino”, manufactured by Gretag-Macbeth (light source: D₅₀; observer: 2°; and filter: status T), and evaluated by the following Evaluation Criteria. It can be said that the greater the OD value is, the better the recording quality.

Recording Quality Evaluation Criteria

A: OD value≧1.24

B: 1.20≦OD value<1.24

C: OD value<1.20

(2) Quick-Drying Ability Evaluation

Using a belt transferring mechanism mounted to a line-type ink-jet recording apparatus, quick-drying ability was evaluated as follows. First, pretreatment liquid of each Example and Comparative Example was applied to the recording paper in the same manner as in the (1) Recording Quality Evaluation except that the pretreatment liquid was applied to the rear surface of the recording paper. Then, recording was performed on the front surface of the recording paper using a pigment ink by an ink-jet method. As Control Examples, also with respect to the recording paper not applied with the pretreatment liquid, recording was performed in the same manner by the ink-jet method (Control Examples 1 and 2). The recorded recording paper was fed between the belt transferring mechanism and the nip roller with the recording surface face up 1.6 seconds after ejection of the pigment ink onto the recording paper. Then, the recording paper was transferred toward the downstream side by rotating the nip roller (diameter of 14 mm) at least four times. Transfer of the pigment ink onto the recording surface of the recording paper that was caused by transfer of the pigment ink at the recording area of the recording paper onto the nip roller was visually evaluated in accordance with the following evaluation criteria.

Quick-Drying Ability Evaluation Criteria

G: Transfer of pigment ink was subsided within quadruple rotation of nip roller

NG: Transfer of pigment ink was not subsided within quadruple rotation of nip roller

(3) Corrosivity Evaluation

In an airtight container, 42 alloy (nickel content: about 42%, iron content: about 58%) test piece was immersed in pretreatment liquid of each Example and Comparative example, and the airtight container was stored in a constant temperature bath at 60° C. for 2 weeks. Thereafter, the test piece was taken out and the weight thereof was measured after removing the pretreatment liquid adhered thereto. Then, on the basis of the following Formula, weight change of the test piece was calculated and degree of corrosion of the test piece due to the pretreatment liquid was evaluated in accordance with the following evaluation criteria.

Weight change (%)=[(Wb−Wa)/Wb]×100

Wb: weight of 42 alloy test piece before immersion in pretreatment liquid

Wa: weight of 42 alloy test piece after immersion in pretreatment liquid

Corrosivity Evaluation Creteria

A: 42 alloy test piece weight change<3%

B: 3%≦42 alloy test piece weight change<5%

C: 5%≦42 alloy test piece weight change<10%

D: 10%≦42 alloy test piece weight change

(4) Comprehensive Evaluation

With respect to the pretreatment liquids of Examples and Comparative Examples, from the results of (1) to (3), comprehensive evaluation was performed in accordance with the following evaluation criteria.

Comprehensive Evaluation Criteria

G: All evaluation results were A, B, or G

NG: C, D, or NG was found in one or more of the evaluation results

Compositions and evaluation results of the pretreatment liquid of each Example are summarized in Table 1. Results of the recording quality evaluation, quick-drying ability evaluation, and corrosivity evaluation were approximately equivalent in both cases of using the ink 1 and the ink 2 as the pigment ink. Compositions and evaluation results of the pretreatment liquid of each Comparative Example and evaluation results of each Control Example are summarized in Table 2. Compositions of the pigment ink used for evaluation tests in (1) and (2) are summarized in Table 3.

TABLE 1

| | | Example 1 | Example 2 | Example 3 | Example 4 | Example 5 | Example 6 | Example 7 | Example 8 | Example 9 |
|---|---|---|---|---|---|---|---|---|---|---|
| Succinic | Acetic acid | 4 | — | 4 | — | 4 | — | 4 | — | — |
| acid, acetic | Sodium acetate | — | — | — | — | — | — | — | — | 4 |
| acid, or the | Succinic acid | — | 4 | — | 4 | — | 4 | — | 4 | — |
| like | | | | | | | | | | |
| Glycol | DPP (1*) | 10 | 10 | 20 | 20 | — | — | — | — | 10 |
| ether | DEHE (2*) | — | — | — | — | 5 | 5 | — | — | — |
| | BTG (3*) | — | — | — | — | — | — | 5 | 5 | — |
| Water | | Balance | Balance | Balance | Balance | Balance | Balance | Balance | Balance | Balance |
| Pigment ink | | Ink 1 | Ink 1 | Ink 1 | Ink 1 | Ink 1 | Ink 1 | Ink 1 | Ink 1 | Ink 1 |
| | | Ink 2 | Ink 2 | Ink 2 | Ink 2 | | | | | |
| Evaluation | Recording | A | A | A | A | A | A | B | B | A |
| | quality | | | | | | | | | |
| | evaluation | | | | | | | | | |
| | Quick-drying | G | G | G | G | G | G | G | G | G |
| | ability | | | | | | | | | |
| | evaluation | | | | | | | | | |
| | Corrosivity | A | A | A | A | A | A | A | A | A |
| | Evaluation | | | | | | | | | |
| | Comprehensive | G | G | G | G | G | G | G | G | G |
| | evaluation | | | | | | | | | |

(1*): DPP = Dipropylene glycol-n-propyl ether
(2*): DEHE = Diethylene glycol-n-hexyl ether
(3*): BTG = Triethylene glycol-n-butyl ether
Amounts of succinic acid, acetic acid, or the like and glycol ether are expressed in wt %

TABLE 2

| | | Comparative | Comparative | Comparative | Comparative | Comparative | Comparative | Comparative | Control | Control |
|---|---|---|---|---|---|---|---|---|---|---|
| | | Example 1 | Example 2 | Example 3 | Example 4 | Example 5 | Example 6 | Example 7 | Example 1 | Example 2 |
| Citric acid | | 4 | — | — | — | — | — | — | — | — |
| Tartaric acid | | — | 4 | — | — | — | — | — | | |
| 1N hydrochloric | | — | — | 5 | — | — | — | — | | |
| acid (4*) | | | | | | | | | | |
| 1N sulfuric acid (5*) | | — | — | — | 5 | — | — | — | | |
| zinc oxide | | — | — | — | — | 1 | — | — | | |
| polyvinylpyrrolidone | | — | — | — | — | — | 5 | 5 | | |
| Glycol | DPP (1*) | 5 | 5 | 5 | 5 | 10 | 10 | — | | |
| ether | BTG (3*) | — | — | — | — | — | — | 10 | | |
| Water | | Balance | Balance | Balance | Balance | Balance | Balance | Balance | | |
| Pigment ink | | Ink 1 | Ink 1 | Ink 1 | Ink 2 | Ink 1 | Ink 1 | Ink 2 | Ink 1 | Ink 2 |
| Evaluation | Recording | C | C | A | A | C | C | C | C | C |
| | quality | | | | | | | | | |
| | evaluation | | | | | | | | | |
| | Quick-drying | NG | NG | G | G | NG | NG | NG | NG | NG |
| | ability | | | | | | | | | |
| | evaluation | | | | | | | | | |
| | Corrosivity | A | A | C | D | A | A | A | — | — |
| | Evaluation | | | | | | | | | |
| | Compre- | NG | NG | NG | NG | NG | NG | NG | NG | NG |
| | hensive | | | | | | | | | |
| | evaluation | | | | | | | | | |

(1*): DPP = Dipropylene glycol-n-propyl ether
(3*): BTG = Triethylene glycol-n-butyl ether
(4*): 1N hydrochloric acid = 1 normal hydrochloric acid (hydrogen ion concentration 1 mol/L)
(5*): 1N sulfuric acid = 1 normal sulfuric acid (hydrogen ion concentration 2 mol/L)
Amounts of acids, zinc oxide, polyvinylpyrrolidone, and glycol ether are expressed in wt %

TABLE 3

| | Ink 1 | Ink 2 |
|---|---|---|
| CAB-O-JET ® 300 (6*) | 40.00 | 40.00 |
| Glycerin | 33.15 | 29.75 |
| DPP (1*) | 2.00 | 1.25 |
| OLFIN ® E1010 (7*) | 0.70 | 0.70 |
| SUNNOL ® NL1430 (8*) | 1.42 | 1.42 |
| Water | Balance | Balance |

(1*): DPP = Dipropylene glycol-n-propyl ether
(6*): manufactured by Cabot Specialty Chemicals, Inc.; carbon black concentration = 15% ink conversion concentration (carbon black concentration with respect to total amount of ink = 6 wt %)
(7*): acetylene glycol surfactant (ethylene oxide (10 mol) additive of acetylene diol, manufactured by Nissin Chemical Industry Co., Ltd, active ingredient amount = 100 wt %)
(8*): polyoxyethylene (3E.O.) alkyl (C = 12, 13) ether sodium sulfate, manufactured by Lion Corporation, active ingredient amount = 28 wt % Each ink component (wt %) indicates actual amount of ink component contained with respect to total amount of each ink

As summarized in Table 1, in cases of using the pretreatment liquids of Examples 1 to 6 and 9, results of the recording quality evaluation and the quick-drying ability evaluation were excellent. Also in cases of using the pretreatment liquids of Examples 7 and 8, results of the recording quality evaluation and the quick-drying ability evaluation were good. None of the pretreatment liquids of Examples 1 to 9 caused corrosion of 42 alloy test piece. In contrast, as summarized in Table 2, in cases of using the pretreatment liquids of Comparative Examples 1 and 2, results of the recording quality evaluation and the quick-drying ability evaluation were insufficient. Further, the pretreatment liquids of Comparative Examples 3 and 4 caused corrosion of 42 alloy test piece. With respect to the pretreatment liquids of Comparative Examples 5 to 7, results of the recording quality evaluation and the quick-drying evaluation were insufficient. Also with respect to Control Examples 1 and 2, results of the recording quality evaluation and the quick-drying evaluation were insufficient.

It will be obvious to those having skill in the art that many changes may be made in the above-described details of the particular aspects described herein without departing from the spirit or scope of the invention as defined in the appended claims.

What is claimed is:

1. A method of ink-jet recording, comprising:
a pretreatment process applying a pretreatment liquid onto a recording medium in advance of ink-jet recording; and
a recording process recording by ejecting a pigment ink onto the recording medium by an ink-jet method, wherein
the pretreatment liquid comprises:
at least one selected from the group consisting of succinic acid, succinic acid salt, acetic acid, and acetic acid salt; and
water.

2. The method of ink-jet recording according to claim 1, wherein an area applied with the pretreatment liquid of the recording medium is at least an area to be recorded of a recording surface of the recording medium to be recorded with the pigment ink.

3. The method of ink-jet recording according to claim 2, wherein in the recording process, pigments in the pigment ink are aggregated at the recording surface due to at least one selected from the group consisting of succinic acid, succinic acid salt, acetic acid, and acetic acid salt.

4. The method of ink-jet recording according to claim 2, wherein the pretreatment liquid further comprises glycol ether.

5. The method of ink-jet recording according to claim 4, wherein the glycol ether is at least one of dipropylene glycol-n-propyl ether and diethylene glycol-n-hexyl ether.

6. The method of ink-jet recording according to claim 2, wherein the pigment ink comprises a self-dispersed pigment.

7. The method of ink-jet recording according to claim 1, wherein an area applied with the pretreatment liquid of the recording medium is at least an area, corresponding to an area to be recorded, of an other side of a recording surface of the recording medium to be recorded with the pigment ink.

8. The method of ink-jet recording according to claim 7, wherein in the recording process, pigments in the pigment ink penetrated into the recording medium from the recording surface are aggregated at an intermediate layer of the recording medium due to at least one selected from the group consisting of succinic acid, succinic acid salt, acetic acid, and acetic acid salt penetrated into the recording medium from the other side of the recording surface.

9. The method of ink-jet recording according to claim 8, wherein the pigment ink comprises a self-dispersed pigment.

10. A pretreatment liquid for applying onto a recording medium in ink-jet recording using a pigment ink in advance of the ink-jet recording, wherein the pretreatment liquid comprises at least one selected from the group consisting of succinic acid, succinic acid salt, acetic acid, and acetic acid salt; and water.

11. The pretreatment liquid according to claim 10, further comprises glycol ether.

12. The pretreatment liquid according to claim 11, wherein the glycol ether is at least one of dipropylene glycol-n-propyl ether and diethylene glycol-n-hexyl ether.

13. An ink set comprising a pigment ink and a pretreatment liquid, wherein the pretreatment liquid is the pretreatment liquid according to claim 10.

14. An ink-jet recording apparatus, comprising:
an ink storing portion; and
an ink ejecting unit, an ink stored in the ink storing portion being ejected by the ink ejecting unit, wherein
the ink-jet recording apparatus further comprises a pretreatment liquid applying unit and the pretreatment liquid is the pretreatment liquid according to claim 10.

15. The ink-jet recording apparatus according to claim 14, wherein the pretreatment liquid applying unit is a unit for applying the pretreatment liquid onto at least an area to be recorded of a recording surface of a recording medium to be recorded with the pigment ink.

16. The ink-jet recording apparatus according to claim 14, wherein the pretreatment liquid applying unit is a unit for applying the pretreatment liquid onto at least an area, corresponding to an area to be recorded, of an other side of a recording surface of a recording medium to be recorded with the pigment ink.

17. A method of improving optical density of a recorded object, comprising:
a pretreatment process applying a pretreatment liquid onto a recording medium in advance of ink-jet recording; and
a recording process recording by ejecting a pigment ink onto the recording medium by an ink-jet method, wherein
the pretreatment liquid comprises at least one selected from the group consisting of succinic acid, succinic acid salt, acetic acid, and acetic acid salt; and water,
optical density of the recorded object is improved by applying the pretreatment liquid onto at least an area to be recorded of a recording surface of the recording medium to be recorded with the pigment ink in the pretreatment process, and
by aggregating pigments in the pigment ink at the recording surface due to at least one selected from the group consisting of succinic acid, succinic acid salt, acetic acid, and acetic acid salt in the pretreatment liquid in the recording process.

18. A method of improving quick-drying ability of a pigment ink, comprising:
a pretreatment process applying a pretreatment liquid onto a recording medium in advance of ink-jet recording; and
a recording process recording by ejecting a pigment ink onto the recording medium by an ink-jet method, wherein
the pretreatment liquid comprises at least one selected from the group consisting of succinic acid, succinic acid salt, acetic acid, and acetic acid salt; and water,
quick-drying ability of the pigment ink is improved by applying the pretreatment liquid onto at least an area corresponding to an area to be recorded of an other side of a recording surface of the recording medium to be recorded with the pigment ink in the pretreatment process, and
by aggregating pigments in the pigment ink penetrated into the recording medium from the recording surface at an intermediate layer of the recording medium due to at least one selected from the group consisting of succinic acid, succinic acid salt, acetic acid, and acetic acid salt penetrated into the recording medium from the other side of the recording surface in the recording process.
